(19) United States
(12) Patent Application Publication
(10) Pub. No.: US 2007/0177102 A1
(43) Pub. Date: Aug. 2, 2007

(54) Method of binding lens to frame

(76) Inventor: Jong Kim, Los Angeles, CA (US)

Correspondence Address: PARK LAW FIRM, 3255 WILSHIRE BLVD, SUITE 1110, LOS ANGELES, CA, 90010, US

(21) Appl. No.: 11/343,124

(22) Filed: Jan. 30, 2006

(51) Int. Cl. G02C 13/00

(52) U.S. Cl. 351/178

(57) ABSTRACT

A method for binding the lens to the frame includes steps of a) aligning one of the holes of the lens with one of the holes of the frame, b) piercing a peg through the aligned holes of the lens and the frame, c) resting the aligned lens and frame on a bench, d) cutting the peg at a predetermined length, e) heat-and-melting the stub of the peg with a heating device, and f) molding the molten stub of the peg with a predetermined shape. The peg is made of plastic. The plastic includes polycarbonate, general plastic, and Marsydur. The peg includes a head and tapered bar, and the peg has an oblong cross-section for keeping the peg from rotating in place. The heating device includes a ultrasonic heater and a laser device.

### BACKGROUND OF THE INVENTION

The present invention relates to a method of binding a lens to a frame. More particularly, the present invention relates to a method and system of binding a lens to a frame.

Binding a lens to a frame is not an easy job to perform. Usually, the lens is an optical object and the frame is a mechanical object. They are manufactured separately surely in different places or factories. In order to perfect a pair of glasses, it is necessary to combine or bind them together.

These days, the lens and the frame in some glasses are made of plastic including polycarbonate, general plastic, and Marsydur. Since metal is not related in these cases, some thermal binding is going to be a very convenient way to bind the lens and the frame.

Even though a thermal binding sounds an old technique, it is a different story to bind the plastic parts together cleanly and stylishly, and most of all, efficiently.

Accordingly, a need for a method and system for binding a lens to a frame has been present for a long time considering the wide usage of the glasses and the recent development of plastic, which has revolutionized the material for glasses. This invention is directed to solve these problems and satisfy the long-felt need.

### SUMMARY OF THE INVENTION

The present invention contrives to solve the disadvantages of the prior art.

An object of the invention is to provide a method of binding a lens to a frame.

Another object of the invention is to provide a method of binding a lens to a frame that use a heating device.

Still another object of the invention is to provide a method and system of binding a lens to a frame.

In the present invention, the lens has a first surface located off the eye side, a second surface located toward the eye side, an inner hole provided at the inner edge through the first and second surfaces for connecting to the frame over the nose, and an outer hole provided at the outer edge through the first and second surface for connecting to the frame over the ear.

And the frame has a L-shaped member and a bridge member. The L-shaped member has a front end, a rear end, a front hole provided at the front end, and a rear hole provided at the rear end. The front end and the front hole are adapted to be connected to the outer hole of the lens, and the rear end and the rear hole are adapted to be connected to the temples. The bridge member has a center bar and two holes provided at the ends of the center bar.

A method for binding the lens to the frame includes steps of a) aligning one of the holes of the lens with one of the holes of the frame, b) piercing a peg through the aligned holes of the lens and the frame, c) resting the aligned lens and frame on a bench, d) cutting the peg at a predetermined length, e) heat-and-melting the stub of the peg with a heating device, and f) molding the molten stub of the peg with a predetermined shape.

The peg is made of plastic. The plastic includes polycarbonate, general plastic, and Marsydur.

The peg includes a head and tapered bar, and the peg has an oblong cross-section for keeping the peg from rotating in place.

The shape of the holes of the lens and the frame are adapted to the cross-sectional shape of the peg.

The lens is made of polycarbonate, and the frame is made of Marsydur.

The heating device includes a soldering gun, a ultrasonic heater, and a laser device.

The step of piercing a peg through the aligned holes of the lens and the frame includes steps of a) putting the frame adjacent to the first surface of the lens, and b) piercing the peg from the second surface of the lens to the first surface of the lens.

The step of resting the aligned lens and frame on a bench includes a step of resting the aligned lens and frame on a metal bench.

The step of cutting the peg at a predetermined length includes steps of a) measuring the predetermined length from the frame with a measuring device, and b) cutting the peg at the measured place. The measuring device includes a spacer with the thickness of the predetermined length. The predetermined length is approximately from point one (0.1) to point five (0.5) millimeters.

The heating device in the step of heat-and-melting the stub of the peg is heated up from one hundred seventy (170) to two hundreds (200) degree in Celsius. The step of heat-and-melting the stub of the peg includes a step of contacting the stub of the peg for approximately five (5) to ten (10) sec.

The heating device in the step of heat-and-melting the stub of the peg contacts the stub of peg at a predetermined shape. The peg includes a head and tapered bar. The peg has an oblong cross-section for keeping the peg from rotating in place. The predetermined shape is concave, and the predetermined shape is substantially same as the shape of the head of the peg.

The bench and the heating device are aligned vertically.

For a system for binding a lens to a frame, the lens has 1) a first surface located off the eye side; 2) a second surface located toward the eye side; 3) an inner hole provided at the inner edge through the first and second surfaces for connecting to the frame over the nose; and 4) an outer hole provided at the outer edge through the first and second surface for connecting to the frame over the ear. And the frame has 1) a L-shaped member having a front end, a rear end, a front hole provided at the front end, and a rear hole provided at the rear end, wherein the front end and the front hole are adapted to be connected to the outer hole of the lens, wherein the rear end and the rear hole are adapted to be connected to the temples; and 2) a bridge member having a center bar and two holes provided at the ends of the center bar.

The system for binding a lens to a frame includes a) a bench, for resting an aligned lens and frame, having an anvil and a support; b) a heating device having a tip and a heat generator; and c) a handle for lowering the tip of the heating device.

The anvil of the bench and the tip of the heating device is aligned vertically.

The heating device includes a soldering gun, a ultrasonic heater, and a laser device. The heating device is heated up from one hundred seventy (170) to two hundreds (200) degree in Celsius, and the shape of the anvil of the bench is adapted to the shape of the head of the peg, wherein the shape of tip of the heating device is substantially same.

The advantages of the present invention are: (1) the method of binding a lens to a frame is easy to use; (2) the method of binding a lens to a frame can make the binding simple, clean, stylish, and efficient; and (3) the system of binding a lens to a frame facilitates the binding process.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of a lens and a frame for the present invention;

FIG. 2 is a perspective view of a system for binding a lens to a frame according to the present invention;

FIG. 3a is a perspective view of a peg;

FIG. 3b is a cross-sectional view of a peg along the line III-III in FIG. 2;

FIG. 4 is a schematic diagram showing an assembled glasses according to the present invention;

FIG. 5 is a perspective view of a spacer;

FIG. 6 is a perspective view of a lens, a frame, and a peg which is being assembled according to the invention;

FIG. 7 is a perspective view of an anvil of the bench;

FIG. 8 is a cross-sectional view along the line VIII-VIII in FIG. 7;

FIG. 9 is a perspective view of a tip of the heating device;

FIG. 10 is a cross-sectional view along the line X-X in FIG. 9; and

FIG. 11 is a flowchart showing the method for binding a lens to a frame according to the present invention.

### DETAILED DESCRIPTION OF THE INVENTION

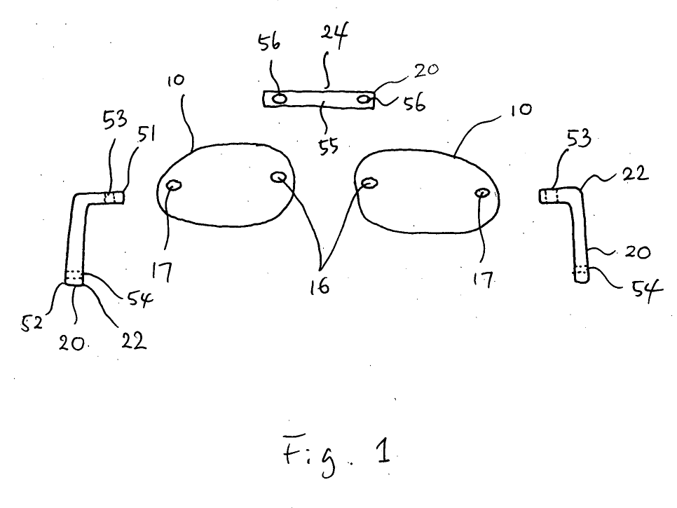

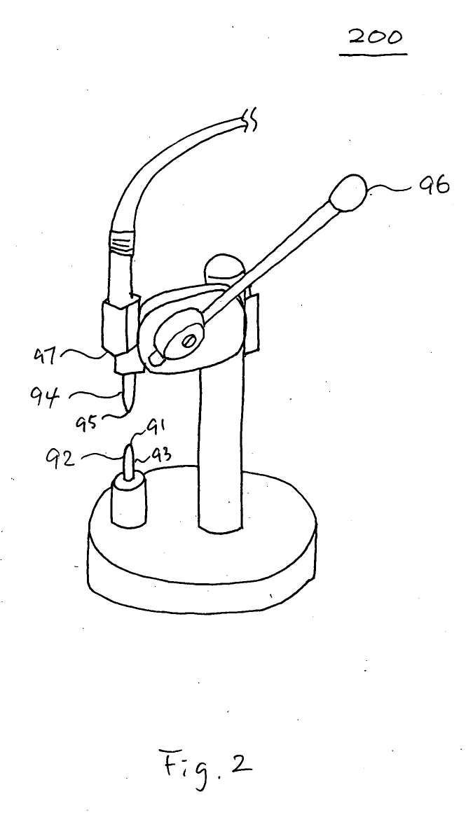

FIG. 1 shows the parts of the glasses that are assembled by the present invention. FIG. 11 shows a flowchart for the method S100, and FIG. 2 show a perspective view of a system 200 for binding a lens 10 to a frame 20 according to the present invention.

In the present invention, the lens 10 has a first surface 12 located off the eye side, a second surface 14 located toward the eye side, an inner hole 16 provided at the inner edge through the first and second surfaces 12, 14 for connecting to the frame 20 over the nose, and an outer hole 17 provided at the outer edge through the first and second surfaces 12, 14 for connecting to the frame 20 over the ear.

And the frame 20 has a L-shaped member 22 and a bridge member 24. The L-shaped member 22 has a front end 51, a rear end 52, a front hole 53 provided at the front end 51, and a rear hole 54 provided at the rear end 52. The front end 51 and the front hole 53 are adapted to be connected to the outer hole 17 of the lens 10, and the rear end 52 and the rear hole 54 are adapted to be connected to the temples (not shown). The bridge member 24 has a center bar 55 and two holes 56 provided at the ends of the center bar 55.

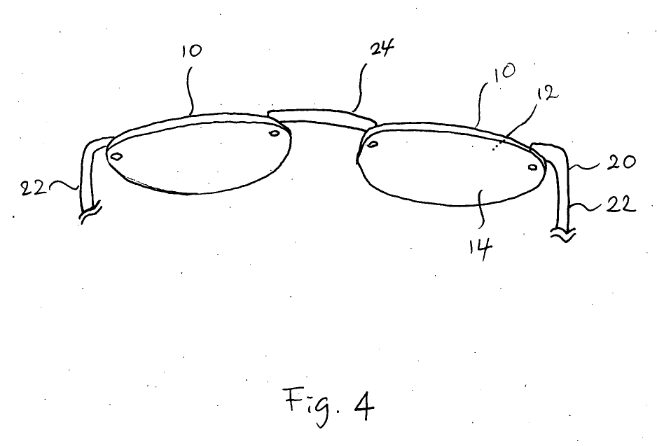

FIG. 4 shows a pair of assembled glasses 200 with the above parts.

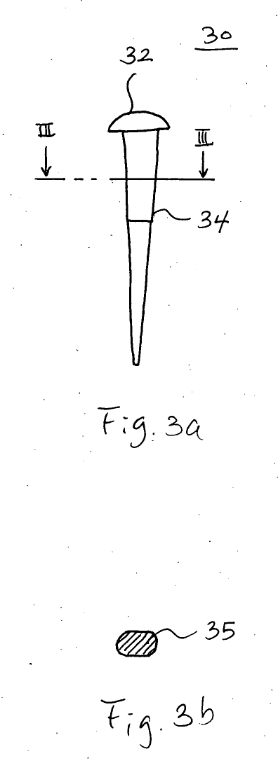

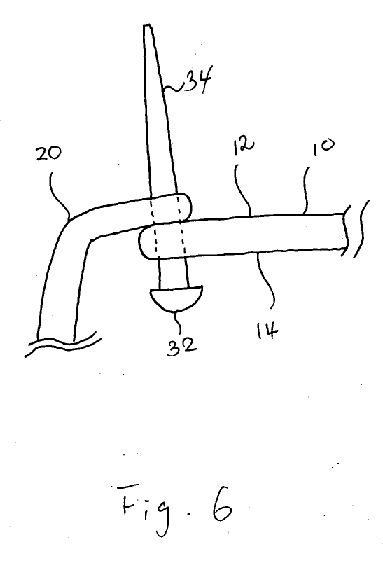

As shown in FIG. 11, the method S100 for binding the lens 10 to the frame 20 includes steps of a) aligning (S10) one of the holes 16, 17 of the lens 10 with one of the holes 53 of the frame 20, b) piercing (S20) a peg 30 (refer to FIG. 3a, FIG. 3b, and FIG. 6) through the aligned holes 16, 17, 53 of the lens 10 and the frame 20, c) resting (S30) the aligned lens 10 and frame 20 on a bench 92, d) cutting (S40) the peg 30 at a predetermined length, e) heat-and-melting (S50) the stub of the peg 30 with a heating device 94 (refer to FIG. 2), and f) molding (S60) the molten stub of the peg 30 with a predetermined shape.

The peg 30 is made of plastic. The plastic includes polycarbonate, general plastic, and Marsydur.

The peg 30 includes a head 32 and tapered bar 34, and the peg 30 has an oblong cross-section 35 for keeping the peg 30 from rotating in place as shown in FIG. 3a and FIG. 3b.

The shape of the holes 16, 17 of the lens 10 and the frame 20 are adapted to the cross-sectional shape of the peg 30.

The lens 10 is made of polycarbonate, and the frame 20 is made of Marsydur.

The heating device 94 includes a soldering gun, a ultrasonic heater, and a laser device.

The step S20 of piercing a peg through the aligned holes of the lens 10 and the frame 20 includes steps of a) putting the frame 20 adjacent to the first surface 12 of the lens 10, and b) piercing the peg 30 from the second surface 14 of the lens 10 to the first surface 12 of the lens 10.

The step S30 of resting the aligned lens 10 and frame 20 on a bench 92 includes a step of resting the aligned lens 10 and frame 20 on a metal bench 92.

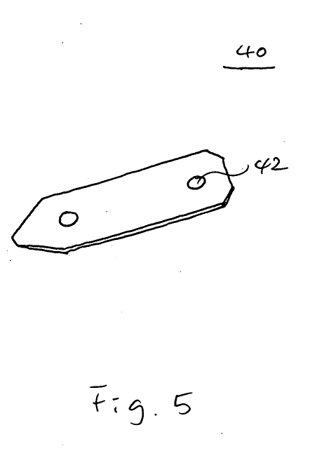

The step S40 of cutting the peg 30 at a predetermined length includes steps of a) measuring the predetermined length from the frame 20 with a measuring device 40 (refer to FIG. 5), and b) cutting the peg 30 at the measured place. The measuring device 40 includes a spacer with the thickness of the predetermined length. The predetermined length is approximately from point one (0.1) to point five (0.5) millimeters. The spacer comprises a hole 42 accommodated to the size of the peg 30. The stub of the peg 30 is inserted through the hole 42 to measure.

The heating device 94 in the step S50 of heat-and-melting the stub of the peg 30 is heated up from one hundred seventy (170) to two hundreds (200) degree in Celsius. The step S50 of heat-and-melting the stub of the peg 30 includes a step of contacting the stub of the peg 30 for approximately five (5) to ten (10) sec.

The heating device 94 in the step of heat-and-melting the stub of the peg 30 contacts the stub of peg 30 at a predetermined shape. The predetermined shape is concave, and the predetermined shape is substantially same as the shape of the head 32 of the peg 30.

The bench 92 and the heating device 94 are aligned vertically.

As shown in FIG. 2, for a system 200 for binding a lens 10 to a frame 20, the lens 10 has 1) a first surface 12 located off the eye side; 2) a second surface 14 located toward the eye side; 3) an inner hole 16 provided at the inner edge through the first and second surfaces 12, 14 for connecting to the frame 20 over the nose; and 4) an outer hole 17 provided at the outer edge through the first and second surfaces 12, 14 for connecting to the frame 20 over the ear. And the frame 20 has 1) a L-shaped member 22 having a front end 51, a rear end 52, a front hole 53 provided at the front end 51, and a rear hole 54 provided at the rear end 52, where the front end 51 and the front hole 53 are adapted to be connected to the outer hole 17 of the lens 10, where the rear end 52 and the rear hole 54 are adapted to be connected to the temples; and 2) a bridge member 24 having a center bar 55 and two holes 56 provided at the ends of the center bar 55.

The system 200 for binding a lens 10 to a frame 20 includes a) a bench 92, for resting an aligned lens 10 and frame 20, having an anvil 91 and a support 93; b) a heating device 94 having a tip 95 and a heat generator 97; and c) a handle 96 for lowering the tip 95 of the heating device 94.

The anvil 91 of the bench 92 and the tip 95 of the heating device 94 is aligned vertically as shown in FIG. 2.

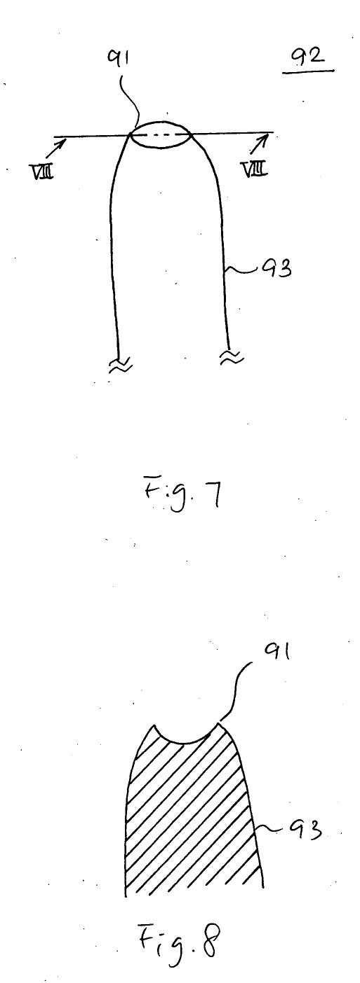

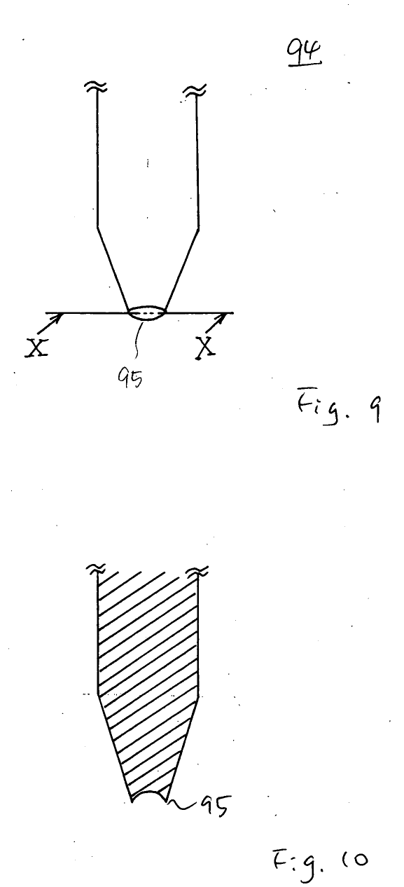

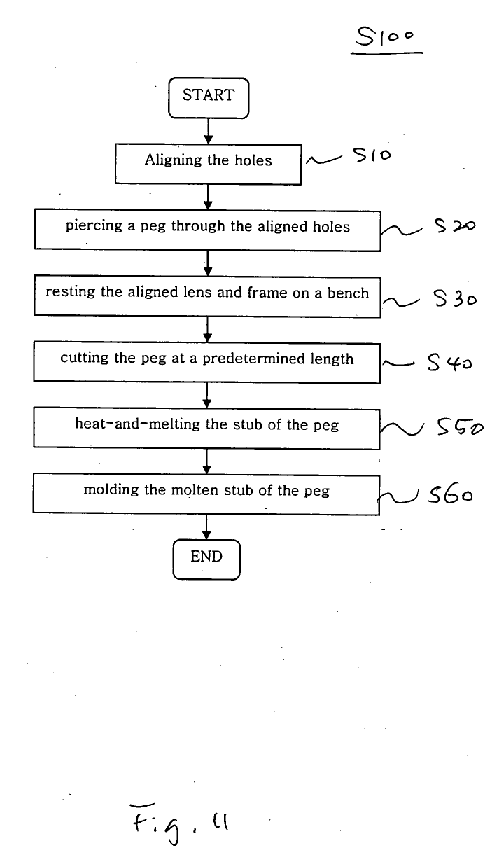

The heating device 94 includes a soldering gun, a ultrasonic heater, and a laser device. The heating device 94 is heated up from one hundred seventy (170) to two hundreds (200) degree in Celsius, and the shape of the anvil 91 of the bench 92 is adapted to the shape of the head 32 of the peg 30, where the shape of tip 95 of the heating device 94 is substantially same as shown in FIGS. 7 through 10.

Marsydur is an anti-toxic material combining rigidity, heat resistance, excellent dimensional stability, chemical resistance, and FDA approval.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A method for binding a lens to a frame, wherein the lens has:
1) a first surface located off the eye side;
2) a second surface located toward the eye side;
3) an inner hole provided at the inner edge through the first and second surfaces for connecting to the frame over the nose; and
4) an outer hole provided at the outer edge through the first and second surface for connecting to the frame over the ear,
wherein the frame has:
1) a L-shaped member having a front end, a rear end, a front hole provided at the front end, and a rear hole provided at the rear end, wherein the front end and the front hole are adapted to be connected to the outer hole of the lens, wherein the rear end and the rear hole are adapted to be connected to the temples; and
2) a bridge member having a center bar and two holes provided at the ends of the center bar, comprising steps of:
a) aligning one of the holes of the lens with one of the holes of the frame;
b) piercing a peg through the aligned holes of the lens and the frame;
c) resting the aligned lens and frame on a bench;
d) cutting the peg at a predetermined length;
e) heat-and-melting the stub of the peg with a heating device; and
f) molding the molten stub of the peg with a predetermined shape.

2. The method for binding a lens to a frame of claim 1, wherein the peg is made of plastic.

3. The method for binding a lens to a frame of claim 2, wherein the plastic comprises polycarbonate, general plastic, and Marsydur.

4. The method for binding a lens to a frame of claim 2, wherein the peg comprises a head and tapered bar, wherein the peg has an oblong cross-section for keeping the peg from rotating in place.

5. The method for binding a lens to a frame of claim 4, wherein the shape of the holes of the lens and the frame are adapted to the cross-sectional shape of the peg.

6. The method for binding a lens to a frame of claim 1, wherein the lens is made of polycarbonate, wherein the frame is made of Marsydur.

7. The method for binding a lens to a frame of claim 1, wherein the heating device comprises a soldering gun, a ultrasonic heater, and a laser device.

8. The method for binding a lens to a frame of claim 1, wherein the step of piercing a peg through the aligned holes of the lens and the frame comprises steps of:
a) putting the frame adjacent to the first surface of the lens; and
b) piercing the peg from the second surface of the lens to the first surface of the lens.

9. The method for binding a lens to a frame of claim 1, wherein the step of resting the aligned lens and frame on a bench comprises a step of resting the aligned lens and frame on a metal bench.

10. The method for binding a lens to a frame of claim 1, wherein the step of cutting the peg at a predetermined length comprises steps of:
a) measuring the predetermined length from the frame with a measuring device; and
b) cutting the peg at the measured place.

11. The method for binding a lens to a frame of claim 10, wherein the measuring device comprises a spacer with the thickness of the predetermined length.

12. The method for binding a lens to a frame of claim 11, wherein the predetermined length is approximately from point one (0.1) to point five (0.5) millimeters.

13. The method for binding a lens to a frame of claim 1, wherein the heating device in the step of heat-and-melting the stub of the peg is heated up from one hundred seventy (170) to two hundreds (200) degree in Celsius.

14. The method for binding a lens to a frame of claim 13, wherein the step of heat-and-melting the stub of the peg comprises a step of contacting the stub of the peg for approximately five (5) to ten (10) sec.

15. The method for binding a lens to a frame of claim 1, wherein the heating device in the step of heat-and-melting the stub of the peg contacts the stub of peg at a predetermined shape.

16. The method for binding a lens to a frame of claim 15, wherein the peg comprises a head and tapered bar, wherein the peg has an oblong cross-section for keeping the peg from rotating in place, wherein the predetermined shape is concave, wherein the predetermined shape is substantially same as the shape of the head of the peg.

17. The method for binding a lens to a frame of claim 1, wherein the bench and the heating device are aligned vertically.

18. A system for binding a lens to a frame, wherein the lens has:
1) a first surface located off the eye side;
2) a second surface located toward the eye side;
3) an inner hole provided at the inner edge through the first and second surfaces for connecting to the frame over the nose; and
4) an outer hole provided at the outer edge through the first and second surface for connecting to the frame over the ear,
wherein the frame has:
1) a L-shaped member having a front end, a rear end, a front hole provided at the front end, and a rear hole provided at the rear end, wherein the front end and the front hole are adapted to be connected to the outer hole of the lens, wherein the rear end and the rear hole are adapted to be connected to the temples; and
2) a bridge member having a center bar and two holes provided at the ends of the center bar, comprising:
a) a bench, for resting an aligned lens and frame, having an anvil and a support;
b) a heating device having a tip and a heat generator; and
c) a handle for lowering the tip of the heating device, wherein the anvil of the bench and the tip of the heating device is aligned vertically.

19. The system for binding a lens to a frame of claim 18, wherein the heating device comprises a soldering gun, a ultrasonic heater, and a laser device.

20. The system for binding a lens to a frame of claim 18, wherein the heating device is heated up from one hundred seventy (170) to two hundreds (200) degree in Celsius, wherein the shape of the anvil of the bench is adapted to the shape of the head of the peg, wherein the shape of tip of the heating device is substantially same.
